(19) United States
(12) Patent Application Publication
(10) Pub. No.: US 2009/0148615 A1
(43) Pub. Date: Jun. 11, 2009

(54) METHOD FOR ATMOSPHERIC PLASMA DEPOSITION OF CONJUGATED POLYMER COATINGS

(75) Inventors: Dirk Vangeneugden, Maasmechelen (BE); Roel Dams, Geel (BE)

Correspondence Address: MERCHANT & GOULD PC, P.O. BOX 2903, MINNEAPOLIS, MN, 55402-0903, US

(73) Assignee: Wiaamse Instelling Voor Technologisch Onderzoek N.V. (VITO), Mol (BE)

(21) Appl. No.: 12/093,567

(22) PCT Filed: Nov. 13, 2006
(86) PCT No.: PCT/BE2006/000122

§ 371 Date: Sep. 15, 2008

(30) Foreign Application Priority Data
Nov. 14, 2005 (EP) 05447253.5

(51) Int. Cl. B05D 1/00

(52) U.S. Cl. 427/489; 427/488

(57) ABSTRACT

A method produces a coating including a conjugated polymer on a substrate. The method includes the steps of: —providing a substrate, —introducing a conjugated polymer coating forming material into an atmospheric pressure plasma discharge, or into the reactive gas stream resulting therefrom, —simultaneously with the introduction of a coating forming material, introducing an additional material into the plasma discharge or the reactive gas stream resulting therefrom, —exposing the substrate to the plasma discharge or the reactive gas stream resulting therefrom, thereby obtaining the coating.

### FIELD OF THE INVENTION

The present invention is related to methods for coating a substrate with a coating comprising conjugated polymers, i.e. polymers with a molecular structure adapted to conduct electricity after the addition of a proper doping element.

### STATE OF THE ART

In general, organic polymers are known to be electrical isolators. However, this view changed by the revolutionary discovery of conductivity in I₂-doped polyacetylene in 1977 by the groups of Alan J. Heeger, Alan G. MacDiamid and Hideki Shirakawa.

Polyacetylene belongs to a special group of organic polymers, conjugated polymers, which have the ability to conduct electricity upon doping. Doping is a chemical process (oxidation or reduction) which creates charges on the polymer chain. Conjugated polymers have alternating single and double bonds, which allow them to transport these charges along the chain and hence conduct electricity.

Among the best known conjugated polymers are polyaniline (PANI), polypyrrole (PPy), polythiophene (PT), polyphenylenevinylene (PPV) and derivatives thereof. Conjugated polymers have some important advantages over classic semiconductors (e.g. silicon semiconductors) which make them very interesting from an economic point of view: they are light weight, flexible and can be used for large-area applications.

Besides the ability to conduct electricity, conjugated polymers have also other unique properties which make them suitable for various applications. They are used today in polymer light emitting diodes (polyLEDs), as antistatic coatings and for corrosion protection of metals. Also some more complex plastic electronic applications are being developed such as organic solar cells, polymeric transistors and organic (bio)sensors.

The chemical structure of conjugated polymers, consisting of alternating single and double bonds, results in rigid polymers which have a very low solubility. Upon doping, the solubility of most polymers is even more reduced. Conjugated polymer coatings are generally formed by chemical or electrochemical techniques. However, some vacuum plasma coating depositions have also been reported. Examples of plasma coating under vacuum of conjugated polymers can be found for example in WO2005/092521, U.S. Pat. No. 6,207,239, US2003/0235648, US2004/0090460, U.S. Pat. No. 6,228,436 and U.S. Pat. No. 6,274,204.

In electrochemical polymerization, a monomer is dissolved into an electrolyte solution of an electrochemical cell. By applying a potential difference between the electrodes, polymerization starts and the conjugated polymer is deposited onto one of the electrodes. In practice, the substrate to be coated is generally used as electrode. For example, the electrodeposition of polypyrrole on a mild steel electrode for corrosion protection, as described by Krstajic, N. V., B. N. Grgur, S. M. Jovanovic and M. V. Vojnovic, Corrosion protection of mild steel by polypyrrole coatings in acid sulfate solutions. Electrochimica Acta, 1997. 42(11): p. 1685-1691. Today, electropolymerization of conjugated polymers is well documented in literature.

During conventional polymerization (radical polymerization, polycondensation, . . . ) of conjugated polymers in solution, precipitation often occurs due to the low solubility of the polymers. This creates difficulties for subsequent purification steps and the coating procedures (spin coating, drop casting, . . . ) on substrates for final application. In order to avoid these drawbacks, monomers with flexible side chains are used to make the resulting conjugated polymers more soluble in (polar or apolar) solvents.

A rather new strategy for forming conjugated polymer coatings is the use of a plasma deposition process. For example, in document EP-A-1144131 or U.S. Pat. No. 6,207,239, a monomer vapor or aerosol is brought into a vacuum chamber and passed through a glow discharge electrode, creating a monomer plasma. In the vacuum plasma, the monomer is polymerized and deposited onto a substrate, forming a conjugated polymer coating. Polymerization in a vacuum plasma is, however, a rather expensive batch technique. Atmospheric plasma polymerizations can be done in a continuous manner with much cheaper equipment. For example, patent EP-A-1326718 describes a method to deposit polymer coatings on a substrate by injecting an aerosol into an atmospheric pressure glow discharge. The document also discloses examples of the deposition of conjugated polymer coatings with this technique. The necessity for a glow discharge and the large inter-electrode gap are still some limitations in the invention of EP-A-1326718. It's difficult to sustain a uniform glow discharge in gasses as nitrogen or air, especially when reactive chemicals are injected in the plasma discharge. For this reason, the carrier gas is restricted to noble gasses as for example Helium.

So far in the prior art, the doping of a conjugated polymer coating takes place after the actual coating step. The drawback of this technique is that it is difficult in this way to obtain a homogeneous distribution of the dopant throughout the coating's thickness. Often, the dopant concentration will be higher near the surface of the coating, than near the coating's contact plane with the substrate. This also has a negative effect on the stability of the dopants, which are more likely to move out of the coating by diffusion.

### AIMS OF THE INVENTION

The present invention aims to provide a method which does not suffer from the drawbacks of the prior art.

### SUMMARY OF THE INVENTION

The invention is related to a method as described in the appended claims. It concerns a method for the deposition of conjugated polymer coatings via atmospheric or intermediate pressure plasma polymerization, with the simultaneous introduction of a second material into the plasma discharge. The second material can be a doping agent. It can be any other chemical agent, added for example for the purpose of obtaining organic/inorganic hybrid coatings. The coating of the invention can be obtained from one specific monomer or a copolymerization of two or more monomers of conjugated polymers. Organic/inorganic hybrid coatings deposited according to the invention, contain conjugated building blocks from a mixture of monomers and said other chemical agents. As such, conjugated polymer coatings can be obtained with improved adhesion to the substrate and better mechanical properties through a higher degree of crosslinking with the coating and with the substrate surface.

### BRIEF DESCRIPTION OF THE DRAWINGS

FIG. 1 illustrates an installation suitable for performing the method of the invention.

FIG. 2 represents the structure of a number of conjugate polymers.

FIG. 3 illustrates a continuous process to form multilayers according to the method of the invention.

FIG. 4 shows the UV-VIS spectrum of the coating of example 2.

FIG. 5 shows the UV-VIS spectrum of the in situ doped plasma polypyrrole coating in example 3, described further.

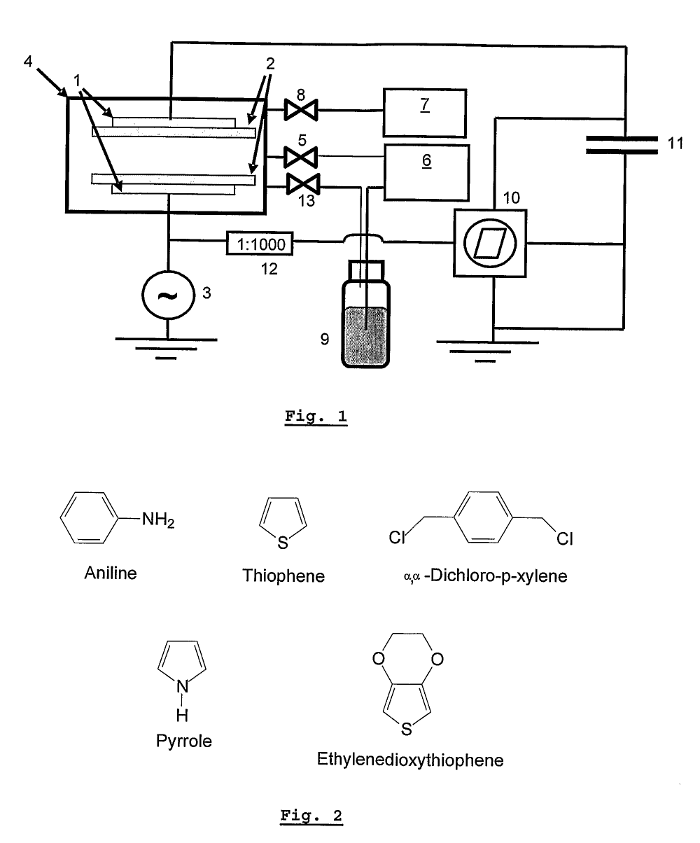

### DETAILED DESCRIPTION OF THE INVENTION

The invention is concerned with a method for forming a conjugated polymer coating on a substrate by plasma deposition. This method is characterized by the introduction of an additional material into the plasma discharge at atmospheric or intermediate (1 mbar to 1 bar) pressure. According to the method, a substrate is placed in or led through a plasma discharge or placed or led through the gas stream coming from a plasma discharge. Injecting a conjugated polymer precursor (monomer) or a plurality of different precursors in the plasma or the gas stream coming from the plasma discharge results in the deposition of a conjugated polymer coating onto the substrate. Simultaneously (i.e. ‘in situ’), the additional material is introduced into the discharge. The second material can be a doping agent (oxidizing, reducing or acid/base agent), injected into the plasma discharge. The additional material is introduced during the plasma deposition, but not necessarily during the whole duration of said deposition. It may be added during one or more timespans, all taking place during the duration of the plasma deposition. The mixing of the conjugated polymer precursor and the additional material may take place before or during the introduction of the materials into the plasma. According to the preferred embodiment, the additional material is introduced through another supply means than the supply means used for introducing the coating forming material. This means that the coating forming material is not mixed with the additional material, before the introduction of the mixture into the plasma discharge. The additional material is thus introduced into the discharge through a channel which is separate from the coating forming material supply, e.g. through a separate aerosol generator. According to another embodiment, two aerosol generators are in place but the atomized materials are mixed before the mixture is introduced into the plasma.

An example of an atmospheric pressure plasma reactor is the dielectric barrier discharge, depicted in FIG. 1. The apparatus (4) comprises a pump (7) to evacuate the gases, possibly with a control valve (8). An inlet port with possibly a control valve for the gases (5) coming from a gas supply unit (6) and the aerosols (13) coming from an aerosol generator (9). It also comprises at least one set of electrodes (1 and 2). The power supply (3) is connected to at least one of the electrodes. The other electrode can be grounded, connected to the power supply (3), connected to a second power supply or connected to the same power supply with an (90°) out of phase potential. Voltage, charge and current measurements can be performed by means of an oscilloscope (10). For this, one can use respectively a voltage probe (12), a capacitor (11) and a current probe. Conditions to create a plasma are a frequency between 50 Hz and 10 MHz, a power range between 0.05 W/cm² and 100 W/cm², and an electrode gap between 0.01 mm and 100 mm.

Besides the dielectric barrier discharge, other techniques for generating an atmospheric pressure plasma may be used, such as for example a RF or microwave glow discharge, a pulsed discharge or a plasma jet. Depending on the application, further adjustments concerning for example mechanical strength, conduction or deposition rate can be achieved by applying an intermediate pressure (0.1 to 1 bar) instead of an atmospheric pressure.

Depending on the application, a different method for injection of the coating forming precursor may be necessary. High precursor concentrations can be injected into the plasma with an aerosol generator. An aerosol can be generated with liquids, solutions or sol-gel. Examples of aerosol generators are ultrasonic nebulizers, bubblers or electrospraying techniques. Electrostatic spraying techniques allow to charge or decharge the precursor before entering the plasma. The precursor can also be injected as a gas or a vapor.

A typical precursor for forming a conjugated polymer coating can be an organic monomer, such as an aromatic heterocycle or substituted benzene. Examples of aromatic heterocyclic precursors include, but are not limited to thiophene, pyrrole and furan. Also derivatives of former heterocycles are interesting precursors. Examples include, but are not limited to 3,4-ethylenedioxythiophene, isothionaphtene, 2,5-dibromothiophene, 2,5-diidothiophene, 2-bromo-5-chlorothiophene, 3-bromo-2-chlorothiophene, 2-bromo-3-methylthiophene, 3-bromo-4-methylthiophene, 2-bromothiophene, 3-bromothiophene, 3-butylthiophene, 2-chlorothiophene, 3-chlorothiophene, 3-methylthiophene, tetrabromothiophene, 2-iodothiophene, thiophene-3-carbaldehyde, 3-acetylthiophene, 2-(3-thienyl)ethanol, thiophene-3-carboxylic acid, 2,3-dibromothiophene, 2,4-dibromothiophene, 3,4-dibromothiophene, 2-chloro-3-methylthiophene, 3-thiophenecarbonyl chloride, 3-thienylmethanol, N-methylpyrrole, 1-(2-aminophenyl)-pyrrole, pyrrole-3-carboxylic acid, 3-(1H-pyrrol-1-yl)aniline, and 4-(1H-pyrrol-1-yl)aniline.

Another type of precursor that can lead to conjugated polymers are substituted benzenes such as for example aniline or α,α-dichloro-p-xylene. Also derivatives of former substituted benzenes may be interesting. Other derivatives of above mentioned precursors are those that have tails substituted on their main structure. Examples of such tails are branched alkyl tails, functionalized alkyl tails, polyethyleneoxide tails. These tails can be used to enhance solubility of the polymers in certain solvents. Also attachment of certain functional groups or enzymes can be made possible which can be useful in for example organic sensors. An example of such functional group for a sensor is a PH active group such as ammonia or acid groups. The substituted tails can also be used to enhance crosslinking. The list above gives a good overview of the available precursors, but the invention is not limited to these precursors.

Conjugated polymers can also be formed from polycyclic aromatic compounds. Examples of polycyclic aromatic compounds include, but are not limited to naphthalene, anthracene, triphenylene, chrysene, coronene, pentacene benzanthracene, perylene, benzoperylene, phenanthrene, pyrene, benzopyrene, rubicene and derivatives thereof.

Most conjugated polymer forming precursors belong to the categories described above. However, there are some exceptions. An example of such an exception is acetylene.

In stead of organic monomers, also oligomers or low molecular weight polymers may be injected into the plasma. These oligomers and polymers are chemically or electrochemically synthesized with one of the above mentioned monomers. Also chemically or electrochemically synthesized copolymers from two or more of the before mentioned monomers may be injected.

Together with a first coating forming material, an additional conjugated polymer forming precursor can be added in order to become a conjugated copolymer coating. Such conjugated copolymers can have, for example, a better conductivity than the two homopolymers. Copolymerization with an organic precursor that does not form conductive polymers may be useful to improve for example crosslinking densities and barrier properties or to introduce certain specific properties such as for example PH buffering. Examples of interesting precursors for copolymerization are (meth)acrylates, which enhance crosslinking. Examples of such acrylates include, but are not limited to methyl methacrylate, methyl acrylate, ethyl acrylate, 2-hydroxyethyl methacrylate, trans-methyl crotonate, trans-ethyl crotonate, butyl acrylate, allyl methacrylate, vinyl crotonate, butyl methacrylate, ethyl-3-ethoxy acrylate, ethylene diacrylate, methylcinnamate, cyclohexyl methacrylate, 4-hydroxybutyl acrylate, hexyl acrylate, methyl-3-methoxy acrylate, 2-hydroxyethyl acrylate, ethylene glycol methyl ether acrylate, lauryl methacrylate, ethyl crotonate, 2-hydroxypropyl methacrylate, isobutyl methacrylate and tert-butyl acrylate.

According to the invention, an additional material is added—in situ—to the plasma, together with the addition of the conjugated polymer coating forming pre-cursor (in the case of a polymer coating) or together with the addition of the plurality of precursors (in the case of a co-polymer coating).

According to a first embodiment of the invention, the additional material is an inorganic or mixed organic/inorganic pre-cursor which forms an organic-inorganic hybrid coating by chemical or physical bonding with the organic conjugated polymer precursor(s). Examples of such an inorganic material are organo silicium precursors. The organo silicium precursor can copolymerize with the conjugated polymer precursor. The so formed copolymer may have a higher crosslinking density which improves mechanical properties of the conjugated plasma coating. The inorganic part of the plasma polymerized hybrid conjugated polymer coating may also react with certain substrates, which improves adhesion to these substrates. Since the plasma polymerization occurs in a continuous gas flow, the concentration of both the conjugated polymer precursor and the hybrid precursor in the plasma stays constant. This results in hybrid conjugated polymer coatings with a homogeneous composition. Examples of organosilicium precursors include but are not limited to hexamethyldisiloxane, diethoxydiethylsilane, glycidoxypropyl trimethoxysilaan, tetraethoxysilane, triethoxyvinylsilane, hexamethyltrisiloxane, hexamethyldisilane, hexamethyldisilazane, methyltriethoxysilane, methyltrimethoxysilane, tetraethylorthosilcate, 3-mercaptopropyltriethoxysilane, vinyltris(2-methoxyethoxy)-silane, allyltriethoxysilane, (3-glycidoxypropyl)-trimethoxysilane. Also metallocenes can be used to form hybrid coatings. Acrylates, organosilicium compounds and metallocenes are the most common used precusors for hybridisation, but the invention is not limited to these types of precursors.

According to a second embodiment the second material is a reagent that adjusts the conductivity to that which is necessary for a certain application. These reagents are called dopants or dedopants. According to the invention, the doping (or dedoping) and polymerization occurs simultaneausly, so that the dopant is built in into the entire bulk of the plasma coating. In situ doping (i.e. simultaneous with the plasma deposition) does not have the disadvantages described above. This bulk doping method results in a stable doping with high conductivities.

As stated, in situ doping can be done by injecting the dopant simultaneously with the coating forming precursor into the plasma. This is done with one of the injection methods described above for the injection of the coating forming precursor. A liquid or dissolved dopant may thus be added as an aerosol, but the dopant can also be injected as a gas or vapour.

There are two types of doping agents, acceptors and donors. Examples of the acceptor type dopant are halogens such as Cl₂, Br₂, I₂, ICl, ICl₃, IBr and IF; Lewis acids such as PF₅, AsF₅, SbF₅, BF₃, BCl₃, BBr₃ and SO₃; protonic acids such as HF, HCl, HNO₃, H₂SO₄, HClO₄, FSO₃H, ClSO₃H and CF₃SO₃H; organic acids such as acetic acid, formic acid and amino acid, transition metal compounds such as FeCl₃, FeOCl, TiCl₄, ZrCl₄, HfCl₄, NbF₅, NbCl₅, TaCl₅, MoCl₅, WF₅, WCl₅, UF₆, LnCl₃ and anions such as Cl⁻, Br⁻, I⁻, Clo⁴⁻, PF⁶⁻, AsF⁵⁻, SbF⁶⁻, BF⁴⁻ and sulfonate anions. Examples of donor dopants are alkaline metals such as Li, Na, K, Rb and Cs; alkaline earth metals such as Ca, Sr and Ba; rare earth metals such as Y, La, Ce, Pr, Nd, Sm, Eu, Gd, Tb, Dy, Ho, Er and Yb; an ammonium ion; R₄P⁺, R₄As⁺ and R₃S⁺ and acetylcholine. Examples of dedoping agents are reducing agents, such as hydrazine or ammonia.

In-situ doping according to the invention has a number of advantages. Doping of the conjugated plasma coating after polymerization is less efficient because the doping material has to penetrate the coating. Usually only a part of the coating is doped. When in situ doping is used, larger doping agents can be incorporated into the plasma polymer coating. This not only dopes the entire bulk of the film but also makes diffusion of the doping agent out of the film more difficult. This gives stable doped conjugated plasma polymer coatings with better conductivity.

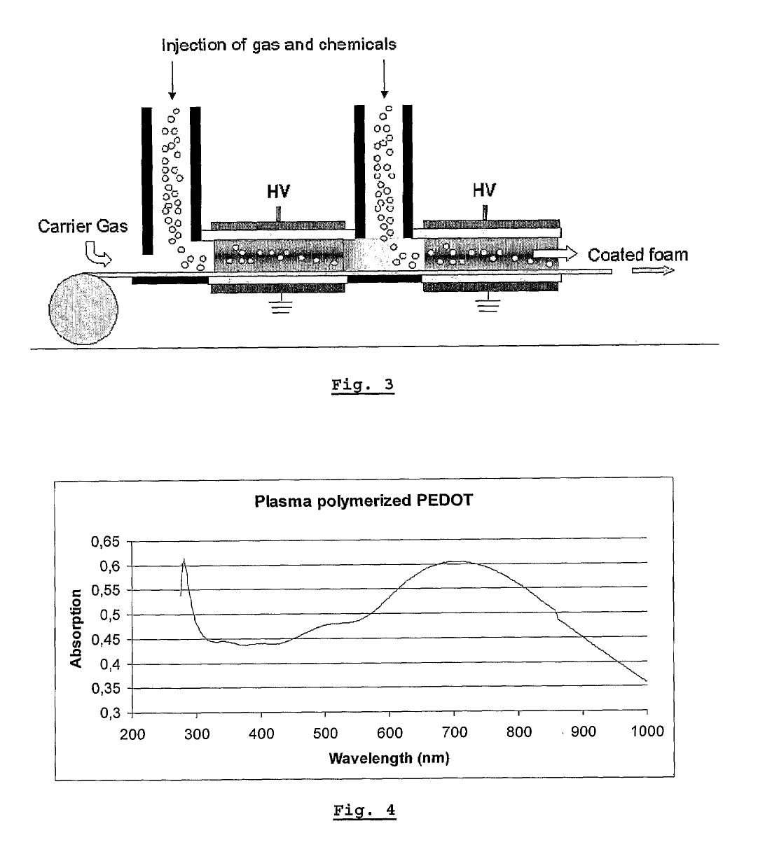

The properties of the conjugated polymer coatings can be further optimized by multi-step plasma processes. For example, an application may exist of a pre-treatment of the substrate with a nitrogen plasma, which improves adhesion with the substrate. In a second step an (in situ doped) conjugated polymer coating may be plasma deposited. In a third finishing step, a barrier coating may be deposited onto the conjugated layer to protect this conjugated plasma polymer layer from environmental influences. Such multi-layer coatings can be formed in one and the same reactor by changing the injected gas mixture and aerosol after a certain period of time. However, from an industrial point of view, it is more interesting to place different atmopheric pressure plasma discharge reactors in a line, to form the multi-layers in a continuous manner. The substrate can be moved by, for example a roll-to-roll system from one reactor to the next where consecutive deposition or activation reactions are performed (FIG. 3).]

### EXAMPLES

### Example 1

For this experiment, a dielectric barrier reactor with one diëlectricum was used. The lower electrode is covered with a glass diëlectricum and a high ac voltage is created on it. The upper electrode consisted of a grounded metal plate. The gap between the upper electrode and the glass was 1.5 mm. A thin glass plate was used as a substrate. After cleaning the substrate with isopropanol, it was placed on the glass diëlectricum.

The conjugated polymer forming precursor is thiophene. It is brought into the plasma reactor by atomizing the thiophene liquid with 2 bar of nitrogen gas. This atomized thiophene is then transported with 20 l/min of nitrogen carrier gas. The plasma was created with a power of 0.13 W/cm² and a frequency of 1.5 kHz. The reaction lasted for 3 minutes.

The plasma reaction leads to a yellow-brown deposition. This coating has a thickness of around 250 nm. Infrared spectroscopy shows a large band around 1400 cm⁻¹ and a couple of small bands around 1550 cm⁻¹ which are typical for a heterocyclic aromatic five ring. This means that at least a part of the conjugated structure is still intact after plasma polymerization. Doping with iodine results in a conductivity of 2×10⁻³ S/cm at a temperature of 20° C. and a relative humidity of 50%.

### Example 2

The same reactor setup as in example 1 is used. The conjugated polymer forming precursor is the thiophene derivative 3,4-ethylenedioxythiophene (EDOT). It is brought into the plasma reactor by atomizing the EDOT liquid with 2 bar of nitrogen gas. This atomized EDOT is then transported with 10 l/min of nitrogen carrier gas that is mixed with 1% oxygen. The frequency used, was 1.5 kHz and the inter electrode gap is 1.5 mm. The plasma was created with a pulsed power of 0.27 W/cm². This means that the power input was not continuous. Power was switched on and of f during polymerization. The ‘on time’ lasted for 5 s each cycle. The ‘off time’, in which there is precursor flow without plasma, also lasted for 5 s each cycle. In this pulsed status, the reaction conditions are less severe and monomer breakdown decreases. The total reaction time was 5 minutes.

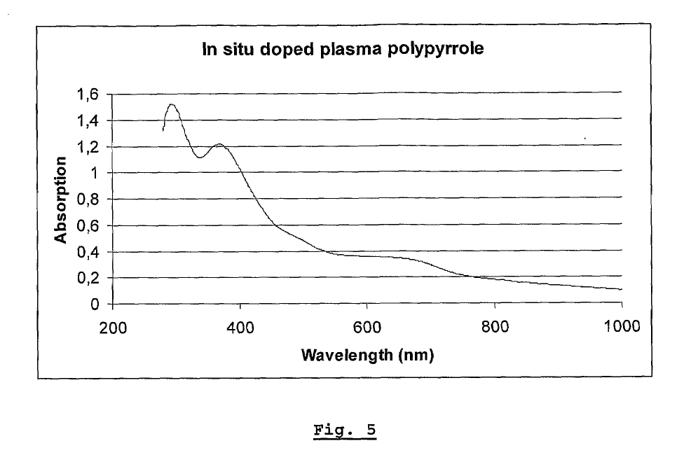

The oxidative environment in the plasma reactor results in an in situ doping of the plasma polymerized polyEDOT coating. A conductivity of 1×10⁻³ S/cm was measured at 20° C. and a relative humidity of 50%. The PEDOT coating has a blue color because of it's absorption in the visible range of the light spectrum. As can be seen in the UV/VIS absorption spectrum (UV/VIS spectroscopy is a technique that measures the light absorption of a material at wavelengths in the visual and the UV-area) (FIG. 4), the plasma polyEDOT has a broad absorption peak around 700 nm, which is typical for the conjugated system of these kind of materials.

### Example 3

In situ doping of plasma polymerized conjugated polymer coatings can be accomplished with the same set-up as in example 1. A second injection channel is used to inject the dopant. The precursor in this example is pyrrole. Iodine vapor is used as a doping agent. It is injected by vaporizing solid iodine, by heating. The iodine vapour is then pumped directly into the plasma.

The conjugated polymer forming precursor, pyrrole, is injected by using an atomizer with a nitrogen pressure of 2 bar. The atomized pyrrole is transported with 10 l/min of nitrogen carrier gas. The plasma was created with a power of 0.18 W/cm² and a frequency of 1.5 kHz. The reaction lasted for 3 minutes.

The FIG. 5 shows the UV-VIS spectrum of the in situ doped plasma polypyrrole coating. Three absorption bands are present. The peak at 290 nm is the absorption of the aromatic ring structure of pyrrole. The absorption band of the η−η* transition of conjugated polypyrrole can be found at 380 nm. At 680 nm the bipolaron absorption of doped polypyrrole can be seen. The presence of the absorption bands at 380 and 680 nm shows that the plasma polymerized polypyrrole has a conjugated system and that this conjugated system is partially doped. Table 1 shows the relative amount of iodine in the conjugated plasma; polymer coating at different depths, measured by XPS. The relative amount of iodine into the coating is 3 to 4 percent. Sputtering of the coating surface, followed by another XPS measurement allows to measure the atomic composition in the bulk of the coating. Measurement of the relative iodine amount after different sputtering times (i.e. at a different depth into the coating) proves that iodine is found in the entire bulk of the coating in equal amounts. In situ doping of plasma polymerized conjugated polymers thus results in a homogeneously doped coating.

TABLE 1

| Sputtering time | 0 s | 5 s | 40 s | 100 s |
|---|---|---|---|---|
| Relative iodine amount | 3.9% | 4.0% | 3.1% | 3.3% |

### Example 4

In order to form an organic/inorganic hybrid coating, in which the organic part is a conjugated polymer (polythiophene), the experiment of example 1 is repeated with co-injection of vinyltriethoxysilane. This second precursor is injected by using a second atomizer with a nitrogen pressure of 0.5 bar.

After a reaction time of 3 minutes a yellow-brown coating is deposited. The thickness of the coating is around 680 nm. IR spectra show that the aromatic thiophene ring is still present (ring stretch band around 1400 cm⁻¹ and ring in plane deformation band around 590 cm⁻¹). Also some vibrations, typical for vinyltriethoxysilane are found in the IR spectra (for example a Si—O stretching band around 1050 cm⁻¹). Further evidence for the presence of both precursors in the final coating is provided by XPS measurements. Table 2 shows that the coating contains both the elements sulfur (2p-electron binding energy: 164 eV) which is only found in thiophene and silicon (2p electron binding energy: 103 eV), which is only found in vinyltriethoxysilane

TABLE 2

| | | |
|---|---|---|
| Electron binding | | Relative amount |
| energy (eV) | Element | (%) |

| | | | |
|---|---|---|---|
| 532 | O | (1s) | 33 |
| 401 | N | (1s) | 7 |
| 285 | C | (1s) | 46 |
| 164 | S | (2p) | 12.5 |
| 103 | Si | (2p) | 1.5 |

### Example 5

In order to form a copolymer coating out of a conjugated (thiophene) and a non-conjugated precursor, the experiment of example 1 is repeated with co-injection of methylmethacrylate. This second precursor is injected by using a second atomizer with a nitrogen pressure of 0.5 bar.

After a reaction time of 3 minutes a yellow-brown coating is deposited. The thickness of the coating is around 580 nm. IR spectra show that the aromatic thiophene ring is still present (ring stretch band around 1400 cm⁻¹ and ring in plane deformation band around 590 cm⁻¹). Also some vibrations, typical for methylmethacrylate are found in the IR spectra (for example C—H stretching bands around 2900 cm⁻¹; carbonyl stretch around 1715 cm⁻¹; C—O ester stretch around 1150 cm⁻¹). Further evidence for the presence of both precursors in the final coating is provided by XPS measurements. Table 3 shows that the coating contains sulfur (2p-electron binding energy: 164 eV) which is only found in thiophene. The large oxygen amount (1s electron binding energy: 532 eV) is due to the copolymerization with methylmethacrylate.

TABLE 3

| | | |
|---|---|---|
| Electron binding | | Relative amount |
| energy (eV) | Element | (%) |

| | | | |
|---|---|---|---|
| 532 | O | (1s) | 28.5 |
| 400 | N | (1s) | 7.5 |
| 285 | C | (1s) | 51.5 |
| 164 | S | (2p) | 12.5 |

1. A method for producing a coating comprising a conjugated polymer on a substrate, comprising the steps of:
providing a substrate,
introducing a conjugated polymer coating forming material into an atmospheric pressure plasma discharge, or into the reactive gas stream resulting therefrom,
simultaneously with the introduction of a coating forming material, introducing an additional material into said plasma discharge or the reactive gas stream resulting
therefrom,
exposing the substrate to said plasma discharge or the reactive gas stream resulting therefrom, thereby obtaining said coating.

2. The method according to claim 1, wherein said second material is a doping or dedoping agent.

3. The method according to claim 1, wherein said second material is an inorganic or mixed organic/inorganic pre-cursor, so that a hybrid organic/inorganic coating is formed.

4. The method according to claim 1, wherein said second material is introduced by generating an aerosol and injecting it into the plasma discharge.

5. The method according to claim 1, wherein said coating forming material consists of one or more organic monomer precursors.

6. The method according to claim 2, wherein said doping or dedoping agent is chosen from the group consisting of Cl₂, Br₂, I₂, ICl, ICl₃, Ibr, IF, PF₅, AsF₅, SbF₅, BF₃, BCl₃, BBr₃ and SO₃, HF, HCl, HNO₃, H₂SO₄, HClO₄, FSO₃H, ClSO₃H, CF₃SO₃H, acetic acid, formic acid and amino acid, FeCl₃, FeOCl, TiCl₄, ZrCl₄, HfCl₄, NbF₅, NbCl₅, TaCl₅, MoCl₅, WF₅, WCl₅, UF₆, LnCl₃, Cl⁻, Br⁻, I⁻, Clo⁴⁻, PF⁶⁻, AsF⁵⁻, SbF⁶⁻, BF⁴⁻ sulfonate anions, Li, Na, K, Rb and Cs, Ca, Sr, Ba, Y, La, Ce, Pr, Nd, Sm, Eu, Gd, Tb, Dy, Ho, Er and Yb, an ammonium ion, R₄P⁺, R₄As⁺, R₃S⁺ and acetylcholine.

7. The method according to claim 3, wherein said additional material is an organo silicium precursor.

8. The method according to claim 1, wherein the additional material is introduced during one or more timespans, all taking place during the duration of the plasma deposition.
